(19) United States
(12) Patent Application Publication
(10) Pub. No.: US 2010/0146997 A1
(43) Pub. Date: Jun. 17, 2010

(54) CONTROLLING PROCESS FOR REFRIGERATOR

(76) Inventors: Yong Hwan Eom, Seoul (KR); Chan Ho Chun, Seoul (KR)

Correspondence Address: KED & ASSOCIATES, LLP, P.O. Box 221200, Chantilly, VA, 20153-1200, US

(21) Appl. No.: 12/593,648

(22) PCT Filed: Jan. 26, 2008
(86) PCT No.: PCT/KR08/00491

§ 371 Date: Feb. 5, 2010

(30) Foreign Application Priority Data
Mar. 30, 2007 (KR) 10-2007-0031655

(51) Int. Cl. G05D 23/32

(52) U.S. Cl. 62/157

(57) ABSTRACT

According to a method of controlling a refrigerator in accordance with the present invention, in the case in which a refrigerating chamber or a freezing chamber has to be cooled, the refrigerating chamber is primarily cooled up to a cooling temperature set higher than a target temperature region and the freezing chamber is then cooled. Accordingly, there is an advantage in that temperatures of the refrigerating chamber and the freezing chamber can be cooled to a temperature wanted by a user more rapidly.

### TECHNICAL FIELD

The present invention relates to a method of controlling a refrigerator and, more particularly, to a method of controlling a refrigerator, in which, when a chamber temperature of a refrigerating chamber or a freezing chamber does not meet a target temperature region, a chamber temperature of the refrigerating chamber is primarily cooled below an upper limit temperature of the refrigerating chamber.

### BACKGROUND ART

In general, a refrigerator includes a compressor, a condenser for condensing refrigerant compressed in the compressor, an expansion valve for expanding the refrigerant condensed in the condenser, an evaporator for evaporating the refrigerant expanded in the expansion valve, and a ventilation fan for ventilating the air through the evaporator in order to improve the evaporation efficiency of the refrigerant introduced into the evaporator.

Here, in the conventional refrigerator, when the temperature of a refrigerating chamber or a freezing chamber does not meet a target temperature, one of the refrigerating chamber and the freezing chamber is cooled up to the target temperature and the other of the refrigerating chamber and the freezing chamber is cooled up to the target temperature. Accordingly, there are problems that the time taken to cool the temperature of the refrigerating chamber or the freezing chamber up to a target temperature is long and the other chamber is not cooled.

### DISCLOSURE OF INVENTION

### Technical Problem

An object of the present invention is to provide a method of controlling a refrigerator, in which, when a chamber temperature of a refrigerating chamber or a freezing chamber does not meet a target temperature region within each chamber upon cooling of a refrigerator, a chamber temperature of the refrigerating chamber is primarily cooled below an upper limit temperature of the refrigerating chamber.

Another object of the present invention is to provide a method of controlling a refrigerator, in which, when a chamber temperature of a refrigerating chamber or a freezing chamber does not meet a target temperature region within each chamber, the refrigerating chamber is primarily cooled, wherein the refrigerating chamber is first cooled below a refrigerating chamber priority cooling temperature, which is set higher than a refrigerating chamber target temperature region, and the freezing chamber is then cooled.

### Technical Solution

The present invention includes a method of controlling a refrigerator, including the steps of preparing a main body partitioned into a refrigerating chamber and a freezing chamber, a refrigerating chamber evaporator disposed in the refrigerating chamber, a freezing chamber evaporator disposed in the freezing chamber, and a compressor for supplying refrigerant to the refrigerating chamber evaporator and the freezing chamber evaporator, setting a target temperature region of the refrigerating chamber between a first upper limit temperature and a first lower limit temperature and setting a refrigerating chamber priority cooling temperature to be higher than the refrigerating chamber target temperature region, setting a target temperature region of the freezing chamber between a second upper limit temperature and a second lower limit temperature and setting a freezing chamber priority cooling temperature to be higher than the freezing chamber target temperature region, and when a temperature of the refrigerating chamber and a temperature of the freezing chamber do not meet the refrigerating chamber target temperature region and the freezing chamber target temperature region, primarily cooling the refrigerating chamber such that the temperature of the refrigerating chamber is at least lower than the refrigerating chamber priority cooling temperature.

In this case, when the temperature of the refrigerating chamber is lower than the refrigerating chamber priority cooling temperature, the cooling of the refrigerating chamber can be stopped and the freezing chamber can be cooled. In particular, the refrigerating chamber can be cooled below the freezing chamber priority cooling temperature.

Further, when the temperature of the freezing chamber is lower than the freezing chamber priority cooling temperature, the cooling of the freezing chamber can be stopped and the refrigerating chamber can be cooled. In particular, the refrigerating chamber can be cooled up to the refrigerating chamber target temperature region.

Further, when the temperature of the refrigerating chamber falls within the refrigerating chamber target temperature region, the cooling of the refrigerating chamber can be stopped and the freezing chamber can be cooled up to the freezing chamber target temperature region. When the temperature of the freezing chamber falls within the freezing chamber target region, the cooling of the freezing chamber can be stopped and the refrigerating chamber can be cooled below the refrigerating chamber target temperature region.

In particular, when the temperature of the refrigerating chamber is below the refrigerating chamber target temperature region, the cooling of the refrigerating chamber can be stopped and the freezing chamber can be cooled below the freezing chamber target temperature region.

Meanwhile, a freezing chamber priority cooling release temperature can be further set between the freezing chamber priority cooling temperature and the second upper limit temperature, and the freezing chamber can be cooled up to the freezing chamber priority cooling release temperature. A refrigerating chamber priority cooling release temperature can be further set between the refrigerating chamber priority cooling temperature and the first upper limit temperature, and the refrigerating chamber can be cooled up to the refrigerating chamber priority cooling release temperature. In this case, the refrigerating chamber priority cooling temperature can be set identical to a first upper limit temperature of the refrigerating chamber.

A method of controlling a refrigerator according to another aspect of the present invention can includes the steps of preparing a main body partitioned into a refrigerating chamber and a freezing chamber, a refrigerating chamber evaporator disposed in the refrigerating chamber, a freezing chamber evaporator disposed in the freezing chamber, and a compressor for supplying refrigerant to the refrigerating chamber evaporator and the freezing chamber evaporator, setting a target temperature region of the refrigerating chamber between a first upper limit temperature and a first lower limit temperature and setting a refrigerating chamber priority cooling temperature to be higher than the refrigerating chamber target temperature region, setting a target temperature region of the freezing chamber between a second upper limit temperature and a second lower limit temperature, and when a temperature of the refrigerating chamber and a temperature of the freezing chamber do not meet the refrigerating chamber target temperature region and the freezing chamber target temperature region, primarily cooling the refrigerating chamber such that the temperature of the refrigerating chamber is at least lower than the refrigerating chamber priority cooling temperature.

In this case, a freezing chamber priority cooling temperature can be further set higher than the freezing chamber target temperature region. When a temperature of the refrigerating chamber is lower than the refrigerating chamber priority cooling temperature after the refrigerating chamber priority cooling step, the cooling of the refrigerating chamber can be stopped and the freezing chamber can be cooled below the freezing chamber priority cooling temperature. After the cooling of the freezing chamber, the refrigerating chamber and the freezing chamber can be alternately cooled at least once. A refrigerating chamber priority cooling release temperature can be further set between the refrigerating chamber priority cooling temperature and the first upper limit temperature. The refrigerating chamber can be cooled up to the refrigerating chamber priority cooling release temperature.

### ADVANTAGEOUS EFFECTS

According to the method of controlling a refrigerator in accordance with the present invention, in the case in which a refrigerating chamber or a freezing chamber should be cooled, the refrigerating chamber is cooled up to a priority cooling temperature set higher than a target temperature region and the freezing chamber is then cooled. Accordingly, there is an advantage in that a user can cool temperatures of the refrigerating chamber and the freezing chamber to a desired temperature more rapidly.

Further, according to the present invention, the refrigerating chamber or the freezing chamber is not cooled up to a target temperature region at once, but the refrigerating chamber and the freezing chamber are cooled up to target temperature regions while alternately cooling the refrigerating chamber and the freezing chamber. Accordingly, there are advantages in that great load applied to a compressor can be prevented and delay time taken to cool each room can be minimized.

Furthermore, according to the present invention, priorities are given to cooling of the refrigerating chamber and the freezing chamber depending on a chamber temperature within the refrigerating chamber or the freezing chamber. Accordingly, there is an advantage in that a temperature within each chamber can be controlled more efficiently.

In addition, according to the present invention, after a chamber temperature of the refrigerating chamber or the freezing chamber falls within a target temperature region, the chamber temperature of the refrigerating chamber is cooled below a first lower limit temperature of the target temperature region and the compressor is then finished. Accordingly, there is an advantage in that, even when the refrigerating chamber is cooled again after the compressor is restarted, refrigerant can move towards the evaporator of the refrigerating chamber smoothly.

### BRIEF DESCRIPTION OF THE DRAWINGS

FIG. 1 is a front view showing a refrigerator in accordance with an embodiment of the present invention;

FIG. 2 is a front view showing the inside of the refrigerator shown in FIG. 1;

FIG. 3 is a perspective view showing respective apparatuses of the refrigerator shown in FIG. 1;

FIG. 4 shows a configuration of the refrigerator shown in FIGS. 3; and

FIG. 5 is a graph showing a temperature change within the refrigerator in accordance with an embodiment of the present invention.

### BEST MODE FOR CARRYING OUT THE INVENTION

The present invention will now be described in detail in connection with preferred embodiments with reference to the accompanying drawings.

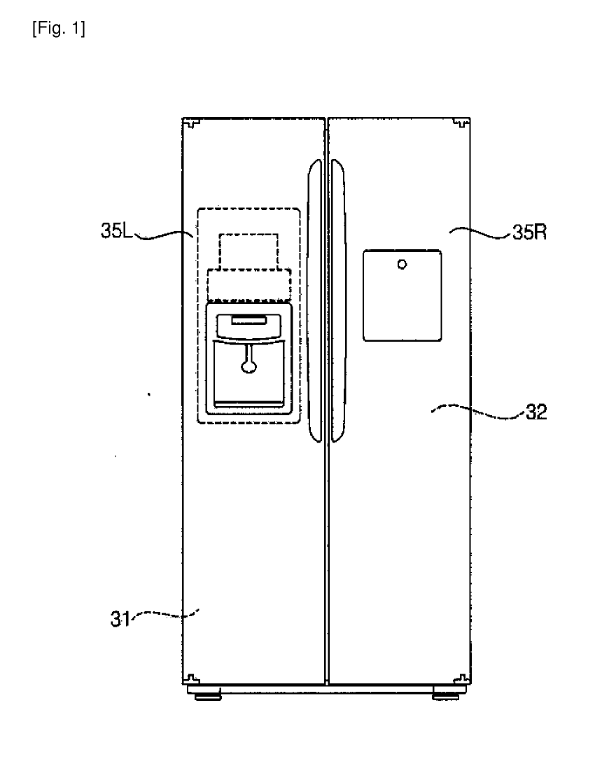

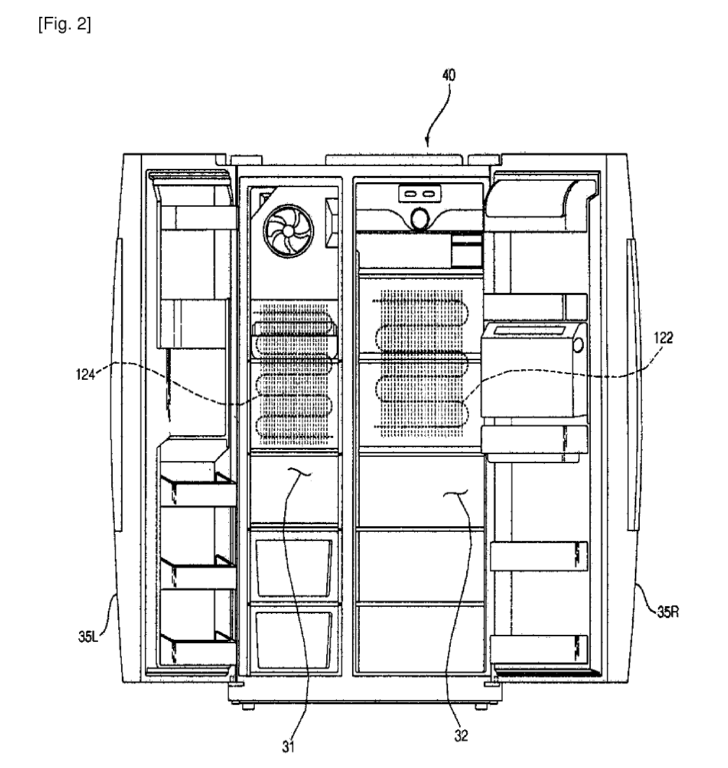

FIG. 1 is a front view showing a refrigerator in accordance with an embodiment of the present invention. FIG. 2 is a front view showing the inside of the refrigerator shown in FIG. 1.

As shown in FIG. 1 or 2, the refrigerator in accordance with the present invention includes a main body 40 provided with a freezing chamber 31 and a refrigerating chamber 32, and doors 35L and 35R hinged to the main body 40 and configured to open/close the freezing chamber 31 and the refrigerating chamber 32, respectively.

Here, the freezing chamber 31 and the freezing chamber 32 are separated from each other by a barrier rib 33 disposed in the main body 40 in order to prevent cooling air within each chamber from flowing through the chamber on the other side. A freezing chamber evaporator and a refrigerating chamber evaporator for cooling respective spaces are disposed in the freezing chamber 31 and the refrigerating chamber 32, respectively.

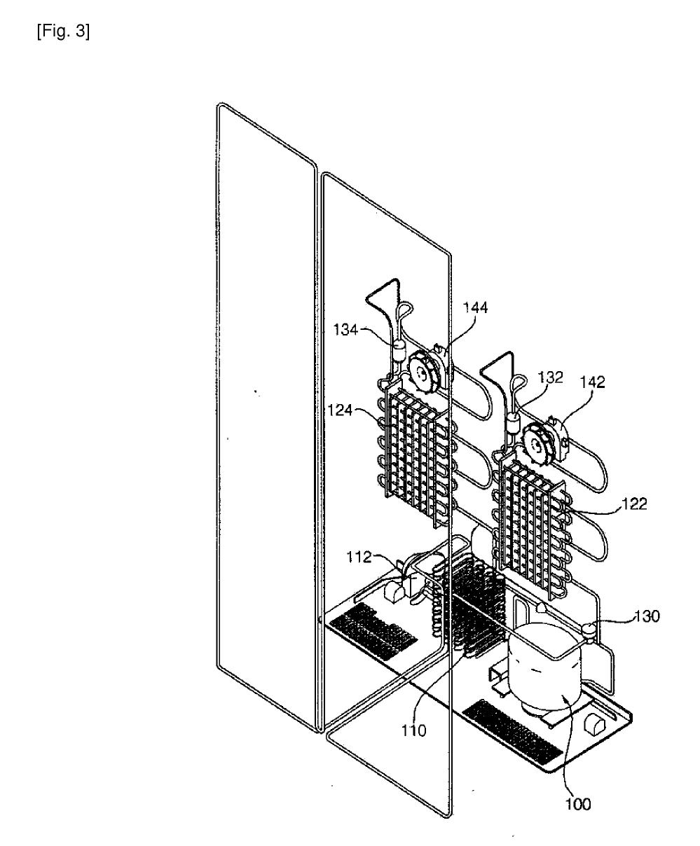

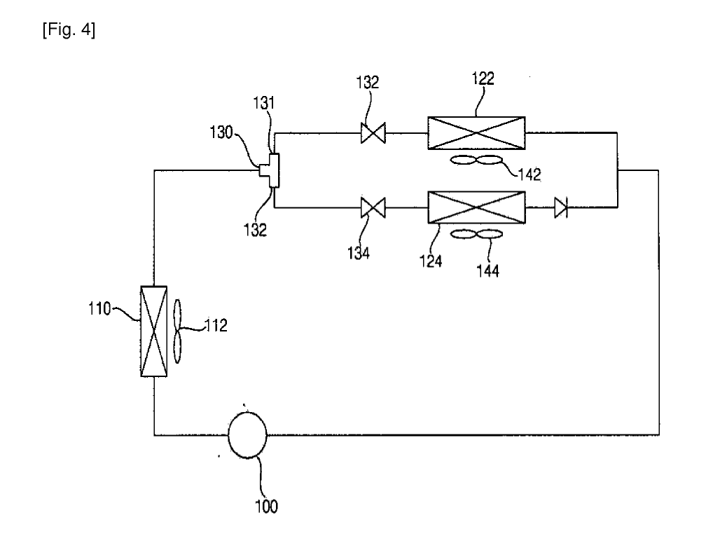

FIG. 3 is a perspective view showing respective apparatuses of the refrigerator shown in FIG. 1. FIG. 4 shows a configuration of the refrigerator shown in FIG. 3.

As shown in FIG. 3 or 4, the refrigerator in accordance with the present embodiment includes a compressor 100, a condenser 110 for condensing refrigerant compressed in the compressor 100, a freezing chamber evaporator 124 configured to evaporate the refrigerant condensed in the condenser 110 and disposed in the freezing chamber 31, a refrigerating chamber evaporator 122 configured to evaporate the refrigerant condensed in the condenser 110 and disposed in the refrigerating chamber 32, a 3-way valve 130 for supplying the refrigerant condensed in the condenser 110 to the refrigerating chamber evaporator 122 or the freezing chamber evaporator 124, a refrigerating chamber expansion valve 132 for expanding the refrigerant supplied to the refrigerating chamber evaporator 122, and a freezing chamber expansion valve 134 for expanding the refrigerant supplied to the freezing chamber evaporator 124.

Here, the refrigerating chamber 32 is equipped with a refrigerating chamber fan 142 for improving the thermal exchange efficiency of the refrigerating chamber evaporator 122 and circulating the air within the refrigerating chamber 32. Further, the freezing chamber 31 is equipped with a freezing chamber fan 144 for improving the thermal exchange efficiency of the freezing chamber evaporator 124 and circulating the air within the freezing chamber 31.

Further, a check valve 150 for preventing the introduction of the refrigerant of the freezing chamber evaporator 124 is disposed on the discharge side of the refrigerating chamber evaporator 122.

The 3-way valve 130 can be opened/closed in order to select the flow passage of the refrigerant supplied from the condenser 110. The 3-way valve 130 can open or close either the refrigerating chamber expansion valve 132 or the freezing chamber expansion valve 134.

Here, the refrigerating chamber-side flow passage of the 3-way valve 130 is called a “R valve 131”, a freezing chamber-side flow passage is called a “F valve 133”, the opening/closing of the refrigerating chamber-side flow passage are called on/off of the R valve 131, and the opening/closing of the freezing chamber-side flow passage are called on/off of the F valve 133.

Meanwhile, although the 3-way valve has been disposed in the present embodiment, an opening/closing valve can be disposed in each of pipelines connected to the refrigerating chamber/freezing chamber evaporators 122 and 124, instead of the 3-way valve.

Hereinafter, a method of controlling a refrigerator in accordance with the present invention is described in detail with reference to FIGS. 3 to 5.

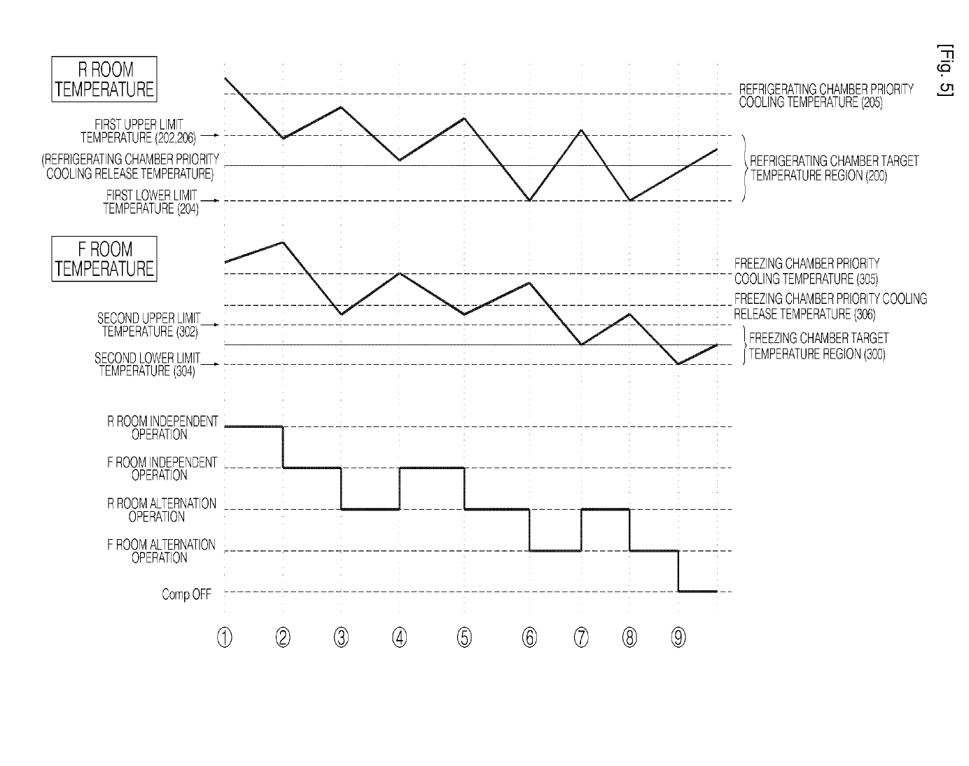

FIG. 5 is a graph showing a temperature change within the refrigerator in accordance with an embodiment of the present invention.

First, a controller (not shown) of the refrigerator sets a refrigerating chamber target temperature region 200, that is, an appropriate chamber temperature of the refrigerating chamber 32 and a freezing chamber target temperature region 300, that is, an appropriate chamber temperature of the freezing chamber 31.

Here, the refrigerating chamber target temperature region 200 is set between a first upper limit temperature 202 and a first lower limit temperature 204. A refrigerating chamber priority cooling temperature 205 is set higher than the refrigerating chamber target temperature region 200. A refrigerating chamber priority cooling release temperature 206 is set between the refrigerating chamber priority cooling temperature 205 and the refrigerating chamber target temperature region 200.

Moreover, the freezing chamber target temperature region 300 is set between a second upper limit temperature 302 and a second lower limit temperature 304. A freezing chamber priority cooling temperature 305 is set higher than the freezing chamber target temperature region 300. A freezing chamber priority cooling release temperature 306 is set between the freezing chamber priority cooling temperature 305 and the refrigerating chamber target temperature region 200.

At this time, in the refrigerating chamber 32 of the present embodiment, the first upper limit temperature 202 and the refrigerating chamber priority cooling temperature are set identically. In the freezing chamber 31, the second upper limit temperature 302 and the freezing chamber priority cooling temperature 305 are set differently.

The controller (not shown) of the refrigerator senses temperatures of the refrigerating chamber 32 and the freezing chamber 31 and controls the 3-way valve 130 depending on sensed temperatures.

Therefore, in the method of controlling a refrigerator in accordance with the present embodiment, first, a chamber temperature of the refrigerating chamber 32 or the freezing chamber 31 is sensed. When the chamber temperature of the refrigerating chamber 32 is higher than the refrigerating chamber priority cooling temperature 205, the refrigerating chamber 32 is first cooled irrespective of a chamber temperature of the freezing chamber 31.

In other words, when a chamber temperature of the refrigerating chamber 32 is higher than the refrigerating chamber priority cooling temperature 205, the R valve 131 is opened to cool the refrigerating chamber 32. This cooling continues until the chamber temperature of the refrigerating chamber 32 becomes below the refrigerating chamber priority cooling release temperature 206 (\textcircled{1}-\textcircled{2}).

In particular, while the refrigerating chamber 32 is primarily cooled, the freezing chamber 31 is not cooled. The temperature of the freezing chamber 31 gradually rises.

Next, when the chamber temperature of the refrigerating chamber 32 is lower than the refrigerating chamber priority cooling temperature 205, the controller checks whether the temperature of the freezing chamber 31 is higher than the freezing chamber priority cooling temperature 305. If, as a result of the check, the temperature of the freezing chamber 31 is higher than the freezing chamber priority cooling temperature 305, the controller opens the F valve 133 and performs cooling until the temperature of the freezing chamber 31 becomes below the freezing chamber priority cooling release temperature 306 (\textcircled{2}-\textcircled{3}).

At this time, while the freezing chamber 31 is cooled, the refrigerating chamber 32 is not cooled. The temperature of the refrigerating chamber 32 gradually rises and is formed between the refrigerating chamber priority cooling temperature 205 and the refrigerating chamber priority cooling release temperature 206.

Next, after the priority cooling of the freezing chamber 31 is released, the controller checks a temperature of the refrigerating chamber 32 again. When the temperature of the freezing chamber 31 is lower than the freezing chamber priority cooling temperature 305 and the temperature of the refrigerating chamber 32 is higher than the first upper limit temperature 202 of the refrigerating chamber target temperature region 200, the controller cools the temperature of the refrigerating chamber 32 to become the refrigerating chamber target temperature region 200, preferably, up to the first lower limit temperature 206 (\textcircled{3}-\textcircled{4}, \textcircled{5}-\textcircled{6})

Next, when the temperature of the refrigerating chamber 32 meets the refrigerating chamber target temperature region 200, if the temperature of the freezing chamber 31 is higher than the second upper limit temperature 302 of the freezing chamber target temperature region 300, the controller cools the freezing chamber 31 in order to control the temperature of the freezing chamber 31 to become the freezing chamber target temperature region 300, more preferably, up to the second lower limit temperature 306 (\textcircled{6}-\textcircled{7}).

Next, when the temperature of the refrigerating chamber 32 and the temperature of the freezing chamber 31 meet the respective target temperature regions 200 and 300, the controller cools the temperature of the refrigerating chamber 32 below the first lower limit temperature 204 and then turns off (OFF) the driving of the compressor 100.

Here, the determination process of the controller is described. Of a chamber temperature of the refrigerating chamber 32 and the freezing chamber 31, the controller primarily meets the temperature of the refrigerating chamber 32.

For example, to lower a chamber temperature of the refrigerating chamber 32 below the refrigerating chamber priority cooling temperature 205 is the top priority. After the refrigerating chamber priority cooling temperature 205 is met, the refrigerating chamber 32 or the freezing chamber 31 is cooled depending on a chamber temperature of the freezing chamber 31.

The priorities are described below. The refrigerating chamber 32 of the refrigerating chamber 32 and the freezing chamber 31 is primarily cooled. The refrigerating chamber 32 or the freezing chamber 31 is controlled to meet a temperature within a chamber in such a way as to meet the priority cooling temperatures 205 and 305 and the target temperature regions 200 and 300 in this order.

The followings are examples of the priorities according to each temperature of the refrigerating chamber or the freezing chamber.

### Example 1

when temperatures of the freezing chamber 31 and the refrigerating chamber 32 are higher than the priority cooling temperatures 205 and 305, respectively, the refrigerating chamber 32 is first cooled and the freezing chamber 31 is then cooled.

### Example 2

when a temperature of the refrigerating chamber 32 is lower than the priority cooling temperature 205 and a temperature of the freezing chamber 31 is higher than the priority cooling temperature 305, the freezing chamber 31 is cooled.

### Example 3

when temperatures of the refrigerating chamber 32 and the freezing chamber 31 are lower than the priority cooling temperatures 205 and 305, respectively, the refrigerating chamber 32 is cooled to the target temperature region 200 and the freezing chamber 31 is cooled to the target temperature region 300.

### Example 4

when a temperature of the refrigerating chamber 32 satisfies the target temperature region 200 and a temperature of the freezing chamber 31 does not satisfy the target temperature region 300, the freezing chamber 31 is cooled.

### Example 5

when a temperature of the refrigerating chamber 32 falls within the target temperature region 200, and a temperature of the freezing chamber 31 rises abruptly due to situations, such as opening of the door of the freezing chamber 31, and thus becomes higher than the target temperature region 300 or the priority cooling temperature 305, the temperature of the freezing chamber 31 is cooled to the target temperature region 300.

### Example 6

when a temperature of the freezing chamber 31 falls within the target temperature region 300, and a temperature of the refrigerating chamber 32 rises abruptly due to situations, such as opening of the door of the refrigerating chamber 32 and thus becomes higher than the target temperature region 200 or the priority cooling temperature 205, the temperature of the refrigerating chamber 32 is cooled to the target temperature region 200.

As described above, according to the present embodiment, while the freezing chamber 31 is alternately cooled in the refrigerating chamber 32, a temperature within a chamber is cooled to each of the lower limit temperatures 204 and 206 of the target temperature regions 200 and 300.

In this case, when a temperature of the freezing chamber 31 or the refrigerating chamber 32 rises abruptly due to situations such as opening the door by a user, the abruptly risen temperature of a chamber is cooled up to a temperature region of the other chamber and the above alternative operation is performed.

Lastly, when the lower limit temperatures 204 and 304 with the respective chambers are reached, a chamber temperature of the refrigerating chamber 32 is cooled below the first lower limit temperature 204 and the compressor 100 is then off.

Here, the reason why, upon the first cooling of the refrigerator, the refrigerating chamber 32 is cooled is that, when the compressor 100 is initially started, effective cooling can be performed even with low load that is generated when the compressor 100 is initially started. In other words, to cool the refrigerating chamber 32 rather than to cool the freezing chamber 31 with low load is advantageous in terms of the operation efficiency of the compressor 100.

Further, in general, the refrigerating chamber is maintained to a temperature ranging from 2 to 5 degrees Celsius so that a user can sense a temperature change more sensitively, whereas the freezing chamber is maintained to a temperature ranging from −12 to −16 degrees Celsius so that a user responds to a temperature change less sensitively.

Therefore, to primarily cool the refrigerating chamber 32, of the refrigerating chamber 32 and the freezing chamber 31, meets a user s requirement resultantly.

Further, according to the present embodiment, in the case in which both the refrigerating chamber 32 and the freezing chamber 31 have to be cooled, a temperature of the refrigerating chamber 32 is not cooled to the target temperature region 200 at once, but is cooled to the priority cooling release temperature 206, which is set higher than the target temperature region 200, and the freezing chamber 31 is then cooled. Accordingly, there is an advantage in that a temperature of each chamber can be cooled at a specific ratio.

Consequently, the present embodiment is advantageous in that it can minimize delay time taken from when the refrigerating chamber 32 is cooled to when the freezing chamber 31 is cooled.

Meanwhile, in the case in which the refrigerating chamber 32 is cooled and the compressor 100 is then off, the compressor 100 is off in a state where an internal pressure of the refrigerating chamber evaporator 122 is lower than that of the freezing chamber evaporator 124. Therefore, when the refrigerator is subsequently operated again, refrigerant can be moved smoothly toward either the refrigerating chamber evaporator 122 or the freezing chamber 124.

Unlike the above, in the case in which, after the freezing chamber 124 is cooled, the compressor 100 is finished and thereafter the refrigerator has to be driven again so as to introduce refrigerant into the refrigerating chamber evaporator 122, an internal pressure of the freezing chamber evaporator 124 is lower than that of the refrigerating chamber evaporator 122, so that the refrigerant is not smoothly introduced into the refrigerating chamber evaporator 122 due to the pressure difference.

Meanwhile, unlike the present embodiment, before the compressor 100 is off, a refrigerant recovery step of recovering refrigerant of the refrigerating chamber evaporator 122 and the freezing chamber evaporator 124 can be performed.

Here, the refrigerant recovery step is performed to smoothly supply refrigerant to the refrigerating chamber evaporator 122 or the freezing chamber evaporator 124 when the compressor 100 is off and then driven again.

In other words, if the compressor 100 stops driving after the freezing chamber 31 is cooled, the refrigerant supplied to the freezing chamber evaporator 124 remains intact and is then slowly evaporated by a temperature change in the chamber. When the compressor 100 is driven in order to cool the refrigerating chamber 32, a pressure within the refrigerating chamber evaporator 122 rises. Accordingly, although the compressor 100 supplies refrigerant, the refrigerant is not smoothly moved to the refrigerating chamber evaporator 122 because of irregularity in the pressure of the freezing chamber evaporator 124 and the refrigerating chamber evaporator 122.

In particular, irregularity in the pressure of the freezing chamber evaporator 124 and the refrigerating chamber evaporator 122 generally occurs when the refrigerating chamber 32 is cooled after the freezing chamber 31 is cooled. It is preferred that refrigerant be recovered after the freezing chamber 31 is cooled.

Further, the refrigerant recovery process of the refrigerator in accordance with the present embodiment is performed in such a manner that both the R valve and the F valve are closed by controlling the 3-way valve 130 while the compressor 100 is being operated and the freezing chamber fan 144 is driven at low speed.

Thus, when the discharge sides of the 3-way valve 130 are all closed, refrigerant is not supplied to the refrigerating chamber evaporator 122 and the freezing chamber evaporator 124. The freezing chamber fan 144 of the freezing chamber evaporator 124, which has been cooled before the recovery of the refrigerant, is driven in a state where the supply of the refrigerant to the refrigerating chamber/freezing chamber evaporators 122 and 124 is cut off.

In this case, as the freezing chamber fan 144 operates, the refrigerant remaining within the freezing chamber evaporator 124 is evaporated and a pressure within the freezing chamber evaporator 124 rises due to thermal exchange. Accordingly, the refrigerant of the freezing chamber evaporator 124 moves towards the compressor 100.

Further, the refrigerating chamber evaporator 122 has not operated before the recovery of the refrigerant. Accordingly, although the refrigerating chamber fan 142 is not operated additionally, a pressure within the refrigerating chamber evaporator 122 is higher than a pressure within the freezing chamber evaporator 124. Further, the refrigerant remaining within the refrigerating chamber evaporator 122 can move towards the compressor 100 smoothly since the compressor 100 is driven.

Therefore, if the compressor 100 is driven as described above, most of the refrigerant, which remains in the 3-way valve 130, the expansion valves 132 and 134, and the refrigerating chamber/freezing chamber evaporators 122 and 124, and a pipeline connecting from the refrigerating chamber/freezing chamber evaporators 122 and 124 to the compressor 100, is stored between the discharge side of the compressor 100 and the 3-way valves 130.

In particular, in the present embodiment, when refrigerant is recovered, the freezing chamber fan 144 is driven in a state where the driving of a condenser fan 112 for ventilating the air through the condenser 110 is stopped.

In this case, the driving of the condenser fan 112 generates an effect of raising an internal pressure on the part of the condenser 110. This has an adverse effect on the recovery of refrigerant.

Further, after the recovery of the refrigerant is completed, the R valve and the F valve of the 3-way valve 130 are opened.

Moreover, the present invention is not limited to the disclosed embodiments and drawings, but can be modified by those skilled in the art within the scope and spirit of the invention.

### INDUSTRIAL APPLICABILITY

As described above, the present invention can be applicable to refrigerators, which can meet a user s requirement, in such a manner that, when a chamber temperature of a refrigerating chamber or a freezing chamber does not meet a target temperature region, a chamber temperature of the refrigerating chamber is primarily cooled below a refrigerating chamber upper limit temperature.

1. A method of controlling a refrigerator, comprising the steps of:
preparing a main body partitioned into a refrigerating chamber and a freezing chamber, a refrigerating chamber evaporator disposed in the refrigerating chamber, a freezing chamber evaporator disposed in the freezing chamber, and a compressor for supplying refrigerant to the refrigerating chamber evaporator and the freezing chamber evaporator;
setting a target temperature region of the refrigerating chamber between a first upper limit temperature and a first lower limit temperature and setting a refrigerating chamber priority cooling temperature to be higher than the refrigerating chamber target temperature region;
setting a target temperature region of the freezing chamber between a second upper limit temperature and a second lower limit temperature and setting a freezing chamber priority cooling temperature to be higher than the freezing chamber target temperature region; and
when a temperature of the refrigerating chamber and a temperature of the freezing chamber do not meet the refrigerating chamber target temperature region and the freezing chamber target temperature region, primarily cooling the refrigerating chamber such that the temperature of the refrigerating chamber is at least lower than the refrigerating chamber priority cooling temperature.

2. The method according to claim 1, wherein when the temperature of the refrigerating chamber is lower than the refrigerating chamber priority cooling temperature, the cooling of the refrigerating chamber is stopped and the freezing chamber is cooled.

3. The method according to claim 1, further comprising the step of, when the temperature of the refrigerating chamber is lower than the refrigerating chamber priority cooling temperature, stopping the cooling of the refrigerating chamber and cooling the freezing chamber below the freezing chamber priority cooling temperature.

4. The method according to claim 3, wherein when the temperature of the freezing chamber is lower than the freezing chamber priority cooling temperature, the cooling of the freezing chamber is stopped and the refrigerating chamber is cooled.

5. The method according to claim 3, wherein when the temperature of the freezing chamber is lower than the freezing chamber priority cooling temperature, the cooling of the freezing chamber is stopped and the refrigerating chamber is cooled up to the refrigerating chamber target temperature region.

6. The method according to claim 5, wherein when the temperature of the refrigerating chamber falls within the refrigerating chamber target temperature region, the cooling of the refrigerating chamber is stopped and the freezing chamber is cooled up to the freezing chamber target temperature region.

7. The method according to claim 6, wherein when the temperature of the freezing chamber falls within the freezing chamber target region, the cooling of the freezing chamber is stopped and the refrigerating chamber is cooled below the refrigerating chamber target temperature region.

8. The method according to claim 7, wherein when the temperature of the refrigerating chamber is below the refrigerating chamber target temperature region, the cooling of the refrigerating chamber is stopped and the freezing chamber is cooled below the freezing chamber target temperature region.

9. The method according to claim 3, wherein:
a freezing chamber priority cooling release temperature is further set between the freezing chamber priority cooling temperature and the second upper limit temperature, and
the freezing chamber is cooled up to the freezing chamber priority cooling release temperature.

10. The method according to claim 1, wherein:
a refrigerating chamber priority cooling release temperature is further set between the refrigerating chamber priority cooling temperature and the first upper limit temperature, and
the refrigerating chamber is cooled up to the refrigerating chamber priority cooling release temperature.

11. The method according to claim 1, wherein the refrigerating chamber priority cooling temperature is set identical to a first upper limit temperature of the refrigerating chamber.

12. A method of controlling a refrigerator, comprising the steps of:
preparing a main body partitioned into a refrigerating chamber and a freezing chamber, a refrigerating chamber evaporator disposed in the refrigerating chamber, a freezing chamber evaporator disposed in the freezing chamber, and a compressor for supplying refrigerant to the refrigerating chamber evaporator and the freezing chamber evaporator;
setting a target temperature region of the refrigerating chamber between a first upper limit temperature and a first lower limit temperature and setting a refrigerating chamber priority cooling temperature to be higher than the refrigerating chamber target temperature region;
setting a target temperature region of the freezing chamber between a second upper limit temperature and a second lower limit temperature; and
when a temperature of the refrigerating chamber and a temperature of the freezing chamber do not meet the refrigerating chamber target temperature region and the freezing chamber target temperature region, primarily cooling the refrigerating chamber such that the temperature of the refrigerating chamber is at least lower than the refrigerating chamber priority cooling temperature.

13. The method according to claim 12, further comprising the steps of:
further setting a freezing chamber priority cooling temperature to be higher than the freezing chamber target temperature region;
when a temperature of the refrigerating chamber is lower than the refrigerating chamber priority cooling temperature after the refrigerating chamber priority cooling step, stopping the cooling of the refrigerating chamber and cooling the freezing chamber below the freezing chamber priority cooling temperature, and
after the cooling of the freezing chamber, alternately cooling the refrigerating chamber and the freezing chamber at least once.

14. The method according to claim 12, wherein:
a refrigerating chamber priority cooling release temperature is further set between the refrigerating chamber priority cooling temperature and the first upper limit temperature, and
the refrigerating chamber is cooled up to the refrigerating chamber priority cooling release temperature.
